(19) United States
(12) Patent Application Publication
(10) Pub. No.: US 2013/0007798 A1
(43) Pub. Date: Jan. 3, 2013

(54) CONTENT RECEIVER, CONTENT USE SYSTEM, AND CONTENT REPRODUCING METHOD

(76) Inventor: Takuya NISHIMURA, Osaka (JP)

(21) Appl. No.: 13/611,948

(22) Filed: Sep. 12, 2012

Related U.S. Application Data
(63) Continuation of application No. PCT/JP2010/006817, filed on Nov. 22, 2010.

(30) Foreign Application Priority Data
Mar. 26, 2010 (JP) 2010-071892

(51) Int. Cl. H04N 21/458

(52) U.S. Cl. 725/29

(57) ABSTRACT

A downloader receives a service providing period within which a service dealer is permitted to perform a viewing service by a content right holder and a viewing period showing a period within which each user is allowed to view a content, with the content, from a server. A license information conversion unit calculates a viewing expiration time for first-time viewing within which the user can view a first-time viewing, by using the service providing period and the viewing period. A writing-out unit writes out the viewing expiration time for first-time viewing and the viewing period, with the content, to an exchangeable medium. When a first viewing time of the user is within the viewing expiration time for first-time viewing, the viewing terminal calculates a viewing expiration time by adding the viewing period to the first viewing time, and writes the viewing expiration time back into the exchangeable medium.

### CROSS-REFERENCE TO RELATED APPLICATIONS

This application is a continuation application of PCT International Patent Application No. PCT/JP2010/006817 filed Nov. 22, 2010, claiming the benefit of priority of Japanese Patent Application No. 2010-071892 filed Mar. 26, 2010, all of which are incorporated by reference herein in their entirety.

### BACKGROUND OF THE INVENTION

1. Field of the Invention

The present invention relates to a content receiver, a content use system, a content reproducing method and the like for writing out a rental content having a limited viewing expiration time to an exchangeable medium.

2. Related Art of the Invention

In recent years, owing to the development of the Internet, techniques for downloading and reproducing movies, music, and the like are generally used. A large number of services are provided for downloading, through networks, contents from servers, which perform content delivery of movies, music, and the like, to PCs, AV apparatuses, cellular phones, and portable apparatuses.

In such content delivery services, there are content sales of a sell-off type with which a user can permanently view purchased content and rental sales with which a user can view downloaded content within a limited viewing expiration time.

In typical content sales of a download type, a content provider which supplies content operates a content server and a DRM server, and a content receiver on a viewer side downloads an encrypted rental content from the content server and acquires, from the DRM server, a decryption key for the encrypted content and viewing conditions for the content. The viewing conditions for the content include information concerning a viewing expiration time within which a user is permitted to view the content and a copy condition for the content.

When the content receiver reproduces the rental content, the content receiver refers to a viewing expiration time designated from the DRM server. If the viewing expiration time has not expired, the content receiver starts reproduction of the content and, if the viewing expiration time has expired, the content receiver carries out deletion of the content.

In some cases, the content receiver writes out a rental content to an exchangeable medium such as an SD card together with the viewing expiration time. In this case, when a reproduction terminal for the SD card starts to reproduce a rental content or has ended the reproduction of the content, the reproduction terminal checks the viewing expiration time for the content, and deletes the content if the viewing expiration time has expired. As a method of reproducing content with viewing period of this type, for example, there is a method described in Japanese Patent Application Laid-Open No. 2003-122643.

FIG. 6 is a diagram showing a sequence in a case where the terminal which has downloaded a content from the server stores the content to be viewed in the terminal in conventional content download. FIG. 7 is a diagram showing a sequence in a case where the terminal writes out the content to the SD card so that the content can be viewed at another terminal.

When the content is viewed at the download terminal 302, as shown in FIG. 6, the download terminal 302 downloads an encrypted rental content from the content server 300 via Internet (not shown) and stores the content in the HDD 303 in the download terminal 302. When the user instructs reproduction of the rental content to be carried out by the download terminal 302, the download terminal 302 transmits a viewing license request 304 to the license server 301 in order to acquire a viewing license for the content from the license server 301. The license server 301 determines a viewing expiration time for the content based on a time of receiving the viewing license request 304 and returns, to the download terminal 302, the viewing expiration time as a viewing license with viewing expiration time 305.

The download terminal 302 extracts a decryption key of the encrypted rental content and the viewing expiration time from the viewing license 305 which has been acquired from the license server 301. The download terminal 302 compares the viewing expiration time with the current time and performs decryption and reproduction of the content when the current time is within the viewing expiration time.

When the download terminal 302 writes out the rental content to the SD card so that the content can be viewed at another terminal, as shown in FIG. 7, the download terminal 302 first transmits a writing-out license request 306 to the license server 301. Unlike the case of the viewing license as described above, the time at which the content is written out to the SD card 308 and the time at which the first-time viewing is started may be far apart. The license server 301 then does not fix the viewing expiration time to set, as a writing-out license with viewing period 307, the viewing period information which shows a length of the time within which the content can be viewed, and returns the writing-out license with viewing period 307 to the download terminal 302. The viewing period information is information of “48-hour viewing is possible,” for example.

The download terminal 302 extracts a decryption key for the encrypted rental content from the received writing-out license with viewing period 307. The download terminal 302 decrypts the encrypted rental content while downloading the encrypted rental content. At the same time, the download terminal 302 performs encryption for writing out the content to the SD card, and writes out the content to the SD card.

In this case, the viewing expiration time is not fixed yet at the time of writing out the content to the SD card. Therefore, as the management information of the rental content recorded in the SD card 308, the viewing expiration time shown by absolute time is not recorded, and the viewing period (viewing period information 311) such as “48-hour” is recorded.

A viewing terminal 310, which reproduces the rental content on the SD card 308, refers to the time information at the first reproduction to change the viewing period into the viewing expiration time information, and the viewing is performed. Therefore, the viewing expiration time is then fixed so that the content can be viewed during 48 hours from the first viewing time, not from the writing-out start time.

However, in the case of the above conventional technology, since the viewing expiration time is not fixed yet when the rental content is written out to the SD card 308, the viewing expiration time will be decided by the viewing terminal 310. Therefore, there is a problem that the service providing period intended by a service dealer or a content right holder is not complied with.

More specifically, when the service dealer acquires the service licensing of a rental content from the content right holder, a service providing period within which the service can be given is decided. Here, the service providing period is a period within which the user is allowed to view the content. For example, when a movie released at a theater is used for rental service, such a service providing period is decided as a service consent condition the service dealer acquires from the content right holder, e.g., the service can be performed only within a period of 270 days from the day after 90 days from the first day of the theater release to the day after 360 days.

In a case of the model, as shown in FIG. 6, such that the download terminal 302 acquires the viewing license with viewing expiration time 305 from the license server 301 at the first reproduction of the rental content, only the judgment that the point in time is within the service providing period for the content is required to be performed when the license server 301 returns the viewing license with viewing expiration time 305 to the download terminal 302. Thus the viewing license with viewing expiration time 305 is not transferred to the download terminal 302 after the end of the service providing period. As a result, the service dealer can prevent the rental content from being viewed at the download terminal 302 after the service providing period, and decision of the viewing expiration time based on the time of the first-time viewing can be realized.

On the other hand, as shown in FIG. 7, in a case of the model writing out a content to the SD card 308 to decide the viewing expiration time based on the time of the first-time viewing, the download terminal 302 has to be given a writing-out license with viewing period 307 beforehand and writes out the license to the SD card 308, and the terminal (not shown) which reproduces the SD card 308 has to change the “viewing period” into the “viewing expiration time”. Therefore, the first reproduction of the content may be performed at a time when the content right holder or the service dealer does not intend reproduction. As a result, there is a problem that the service dealer cannot comply with the service providing period.

In view of the above-described conventional problems, it is an object of the present invention to provide a content receiver, a content use system, a content reproducing method and the like which can comply with a service providing period even when a content such as a rental content the viewing expiration time of which is not fixed is written out to an exchangeable medium.

### SUMMARY OF THE INVENTION

The 1^{st} aspect of the present invention is a content receiver which receives a content that is permitted to be viewed during a permitted viewing period of a predetermined time length from a first reproduction, from a content server and writes out the content to an exchangeable medium, the content receiver comprising:

a period information receiving unit which receives, from the content server, information about the permitted viewing period and a fixed providing period, the fixed providing period being a period which is fixed by an absolute time for every content and during which a reproduction is permitted;

a reproduction startable period creation unit which acquires a reproduction startable period during which a start of the reproduction is permitted, based on the permitted viewing period and the fixed providing period; and

a writing-out unit which writes out the reproduction startable period, the permitted viewing period and the content, to the exchangeable medium.

The 2^{nd} aspect of the present invention is the content receiver according to the 1^{st} aspect of the present invention, wherein

the reproduction startable period creation unit assigns, as a last time of the reproduction startable period, a time which is obtained by subtracting the permitted viewing period from a last time of the fixed providing period.

The 3^{rd} aspect of the present invention is the content receiver according to the 1^{st} aspect of the present invention, wherein

when a timing of writing-out exceeds the reproduction startable period, the writing-out unit does not write out the content to the exchangeable medium.

The 4^{th} aspect of the present invention is the content receiver according to the 1^{st} aspect of the present invention, wherein

when a timing of writing-out exceeds the reproduction startable period but does not exceed the fixed providing period, the writing-out unit writes out a last time of the fixed providing period as an expiration time limit at which the content can be viewed, to the exchangeable medium.

The 5^{th} aspect of the present invention is a content use system comprising: a content server which stores a content that is permitted to be viewed during a permitted viewing period of a predetermined time length from a first reproduction; a content receiver which receives the content from the content server and writes out the content to an exchangeable medium; and a content reproducer which reproduces the content recorded on the exchangeable medium, wherein

the content server includes a period information transmitting unit which transmits, to the content receiver, information about the permitted viewing period and a fixed providing period, the fixed providing period being a period which is fixed by an absolute time for every content and during which a reproduction is permitted,

the content receiver includes a period information receiving unit which receives the permitted viewing period and the fixed providing period from the content server, a reproduction startable period creation unit which acquires a reproduction startable period during which a start of the reproduction is permitted, based on the permitted viewing period and the fixed providing period, and a writing-out unit which writes out the reproduction startable period, the permitted viewing period and the content to the exchangeable medium, and

the content reproducer includes a content reproduction unit which compares a present time with the reproduction startable period at a time of starting reproduction of the content recorded on the exchangeable medium, (i) adds the permitted viewing period to the present time, sets the added time as an expiration time limit at which the content can be viewed, and reproduces the content, when the present time is within the reproduction startable period, (ii) does not reproduce the content, when the present time is before the reproduction startable period, (iii) and does not reproduce the content, when the present time is after the reproduction startable period and a predetermined condition is satisfied.

The 6^{th} aspect of the present invention is the content use system according to the 5^{th} aspect of the present invention, wherein

the predetermined condition is that the present time has exceeded an added time which is obtained by adding the permitted viewing period to a last time of the reproduction startable period, and

when the present time is after the reproduction startable period and does not exceed the added time, the content reproduction unit sets the added time as the expiration time limit and reproduces the content.

The 7^{th} aspect of the present invention is the content use system according to the 5^{th} aspect of the present invention, wherein

when the present time has exceeded the reproduction startable period, the content reproduction unit deletes or invalidates the content irrespective of whether the predetermined condition is satisfied.

The 8^{th} aspect of the present invention is a content reproducing method for a content use system including a content server which stores a content that is permitted to be viewed during a permitted viewing period of a predetermined time length from a first reproduction, a content receiver which receives the content from the content server and writes out the content to an exchangeable medium, and a content reproducer which reproduces the content recorded on the exchangeable medium, the content reproducing method comprising:

a period information transmitting step of transmitting, from the content server to the content receiver, information about the permitted viewing period and a fixed providing period, the fixed providing period being a period which is fixed by an absolute time for every content and during which a reproduction is permitted;

a reproduction startable period creation step of, by the content receiver, acquiring a reproduction startable period during which a start of the reproduction is permitted, based on the permitted viewing period and the fixed providing period;

a writing-out step of, by the content receiver, writing out the reproduction startable period, the permitted viewing period and the content to the exchangeable medium; and

a content reproduction step of, by the content reproducer, comparing a present time with the reproduction startable period at a time of starting reproduction of the content recorded on the exchangeable medium, (i) adding the permitted viewing period to the present time, setting the added time as an expiration time limit at which the content can be viewed, and reproducing the content, when the present time is within the reproduction startable period, (ii) not reproducing the content, when the present time is before the reproduction startable period, (iii) and not reproducing the content, when the present time is after the reproduction startable period and a predetermined condition is satisfied.

The 9th aspect of the present invention is a non-transitory computer-readable medium having a program stored thereon, wherein the program causes a computer to execute the content reproducing method according to the 8^{th} aspect of the present invention.

The present invention can provide a content receiver, a content use system, a content reproducing method and the like which can comply with a service providing period even when a content such as a rental content the viewing expiration time of which is not fixed is written out to an exchangeable medium.

### BRIEF DESCRIPTION OF THE DRAWINGS

FIG. 1 is a diagram showing a configuration of a download system according to a first embodiment of the present invention;

FIG. 2(A) is a diagram showing an example of a configuration of license information which a download terminal acquires from a server according to the first embodiment of the present invention;

FIG. 2(B) is a diagram showing an example of a configuration of the license information created by a license information conversion unit according to the first embodiment of the present invention;

FIG. 2(C) is a diagram showing an example of a configuration of the license information for which a viewing expiration time judgment unit has fixed a viewing expiration time according to the first embodiment of the present invention;

FIG. 3 is a diagram showing a relation between each period and each time shown by the license information according to the first embodiment of the present invention;

FIG. 4 is a flowchart of the viewing expiration time decision processing by the viewing expiration time judgment unit in a viewing terminal according to the first embodiment of the present invention;

FIG. 5 is a diagram showing an example of a configuration of the license information created by the license information conversion unit when an encrypted rental content is written out to an SD card in an unreservable period of the viewing period, according to the first embodiment of the present invention;

FIG. 6 is a diagram showing a sequence in a case where a terminal downloads a content from a server and the content is viewed at the terminal in a conventional content download system; and

FIG. 7 is a diagram showing a sequence in a case where the content is viewed at a terminal other than the terminal which has downloaded the content in the conventional content download system.

### DESCRIPTION OF SYMBOLS

100 Server
101 Encrypted rental content
102 License information
103 Content ID
104 Decryption key
105 Service providing period
106 Viewing period
109 Transmitting unit
110 Download terminal
111 Downloader
112 SD card writing-out unit
113 SD card
114 License information conversion unit
115 License information
116 Viewing expiration time for first-time viewing
117 Viewing expiration time
120 Viewing terminal
121 SD card reading and writing unit
123 Viewing expiration time judgment unit
124 Reproduction control unit
125 License information
130 Service start time
131 Service last time
132 Viewable last time for first-time viewing
133 Viewing start time for first-time viewing
140 Unreservable period of the viewing period
141 License information
300 Content server
301 License server
302 Download terminal
303 HDD
304 Viewing license request
305 Viewing license with viewing expiration time
306 Writing-out license request
307 Writing-out license with viewing period
308 SD card
310 Viewing terminal
311 Viewing period information

### PREFERRED EMBODIMENTS OF THE INVENTION

Embodiments of the present invention are explained below with reference to the drawings.

### First Embodiment

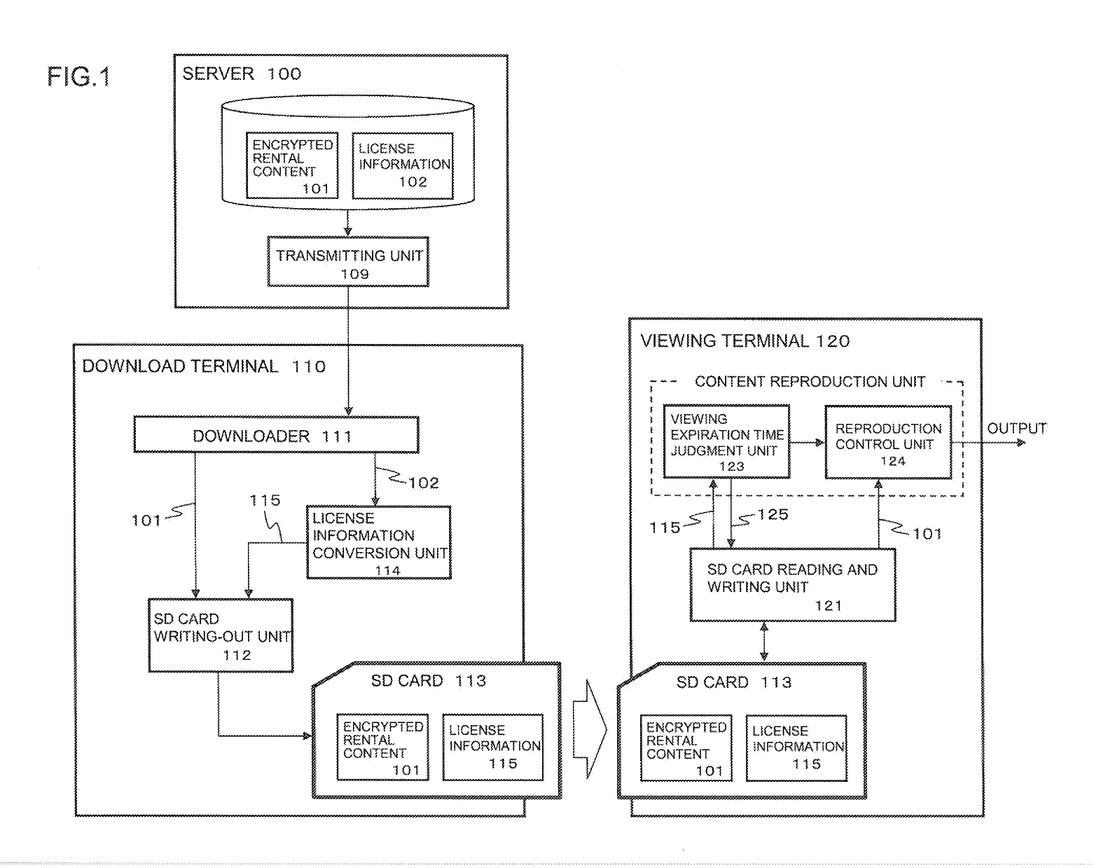

FIG. 1 is a block diagram of a download system according to a first embodiment of the present invention.

A downloader 111 in a download terminal 110 downloads an encrypted rental content 101 from a server 100, which is connected to the downloader 111 through a network (not shown) such as Internet, and writes the content into an SD card 113 by a card writing-out unit 112. The downloader 111 similarly acquires license information 102 related with the downloaded encrypted rental content 101. The downloader 111 changes the license information 102 into license information 115 by using a license information conversion unit 114 and writes the information 115 into the SD card 113 by using the card writing-out unit 112.

A transmitting unit 109 in the server 100 transmits the encrypted rental content 101, which is protected by copyright and is stored in the server 100, and the license information 102 to the download terminal 110, according to a request from the downloader 111 in the download terminal 110.

The download terminal 110 corresponds to an example of a content receiver according to the present invention. The server 100 corresponds to an example of a content server according to the present invention. The SD card 113 corresponds to an example of an exchangeable medium according to the present invention. An exchangeable medium is a recording medium which can be exchanged. The downloader 111 corresponds to an example of a period information receiving unit according to the present invention. The card writing-out unit 112 corresponds to an example of a writing-out unit according to the present invention. The license information conversion unit 114 corresponds to an example of a reproduction startable period creation unit according to the present invention. The transmitting unit 109 in the server 100 corresponds to an example of a period information transmitting unit according to the present invention. The encrypted rental content 101 which is downloaded from the server 100 corresponds to an example of a content that is permitted to view during a permitted viewing period that is a predetermined time length from the first reproduction according to the present invention.

When the SD card 113, to which the encrypted rental content 101 and the license information 115 have been written out at the download terminal 110, is inserted into a viewing terminal 120, the encrypted rental content 101 can be viewed at the viewing terminal 120 other than the download terminal 110.

An SD card reading and writing unit 121 in the viewing terminal 120 reads out the encrypted rental content 101 and the license information 115 which are recorded in the SD card 113. A viewing expiration time judgment unit 123 judges, according to the information related to the viewing expiration time included in the license information 115, whether the encrypted rental content 101 can be reproduced. When it is judged that the encrypted rental content 101 can be reproduced, a reproduction control unit 124 decrypts the encrypted rental content 101 and reproduces the content 101 for output on a screen built in the viewing terminal 120 or on a display connected to the viewing terminal 120.

The viewing terminal 120 corresponds to an example of a content reproducer according to the present invention. A configuration including the viewing expiration time judgment unit 123 and the reproduction control unit 124 corresponds to an example of a content reproduction unit according to the present invention.

The license information conversion unit 114 acquires the license information 102 from the server 100 and creates the license information 115 to be written into the SD card.

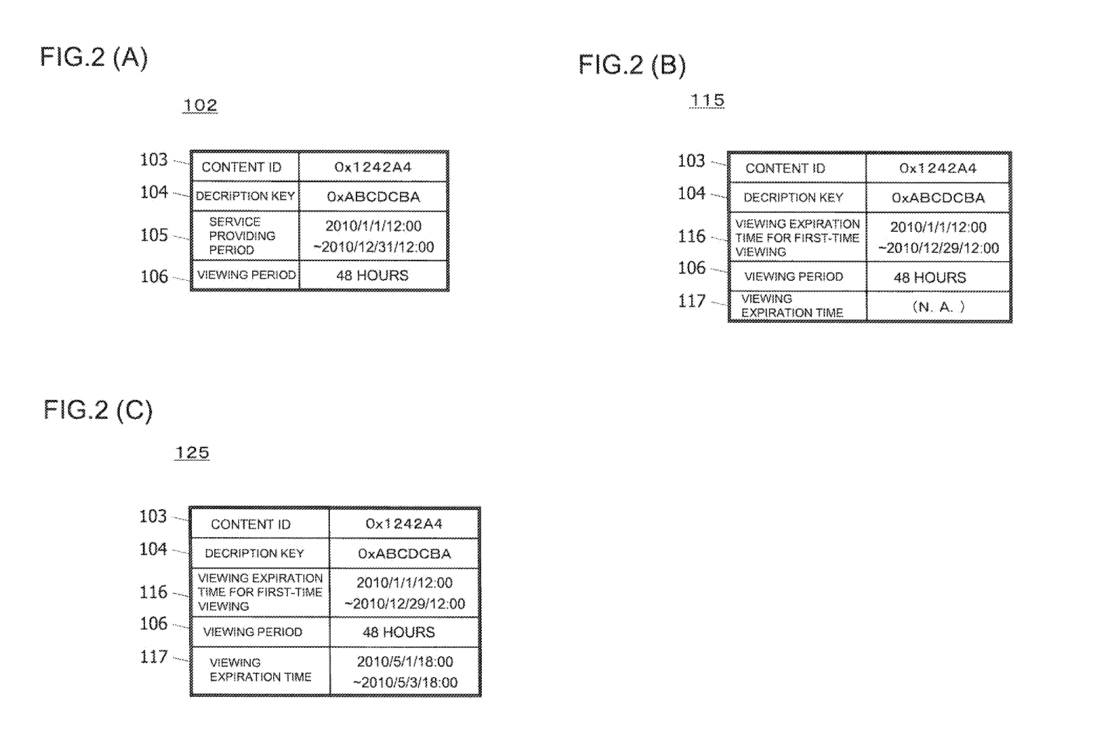

FIG. 2(A) shows an example of a configuration of the license information 102 which the download terminal 110 has acquired from the server 100. FIG. 2(B) shows an example of a configuration of the license information 115 created by the license information conversion unit 114.

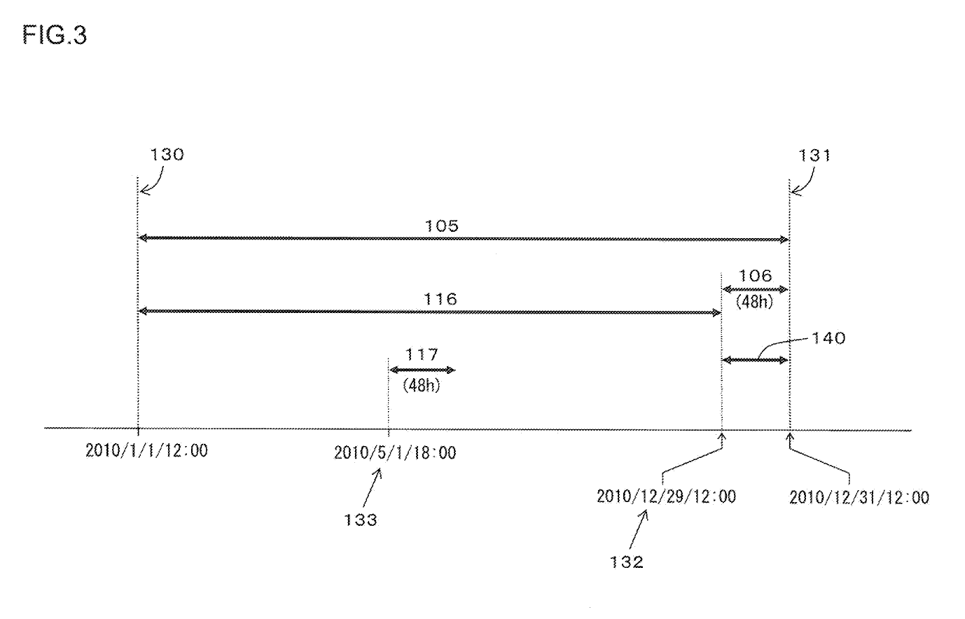

FIG. 3 shows a relation between each period and each time shown by the license information 102 and the license information 115.

As shown in FIG. 2(A), the license information 102 related to the encrypted rental content 101, which has been downloaded by the download terminal 110 from the server 100, comprises a content ID 103 which is an identifier of the encrypted rental content 101, a decryption key 104 for decrypting the encrypted rental content 101, a service providing period 105 within which the service dealer is permitted to perform the rental service of the content by the content right holder, and a viewing period 106 showing a period starting from the first-time viewing, within which the content can be viewed.

The service dealer sells a right to allow the user to view the content during the viewing period, which is indicated by the viewing period 106, within a period indicated by the service providing period 105. A user cannot view the encrypted rental content 101 at a time that is not within the service providing period 105, since, if he or she can do so, this means a breach of contract the service dealer made with the content right holder.

The service providing period 105 corresponds to an example of a fixed providing period according to the present invention. The viewing period 106 corresponds to an example of a permitted viewing period according to the present invention.

A concrete example of a creation method of the license information 115 in the license information conversion unit 114 is described in what follows. The license information conversion unit 114 stores, as a viewing expiration time for first-time viewing 116, a period obtained by subtracting the length of the time shown by the viewing period 106 from the service providing period 105 described in the license information 102.

The viewing expiration time for first-time viewing 116 corresponds to an example of a reproduction startable period according to the present invention.

In a case of the example shown in FIG. 2(A), the service providing period 105 is, as shown in FIG. 3, a period from a service start time 130 (2010/1/1/12:00) to a service last time 131 (2010/12/31/12:00). The license information conversion unit 114 assumes that the start time is the service start time 130 of the service providing period 105. The license information conversion unit 114 sets, as the last time, a last time for first-time viewing 132 (2010/12/29/12:00) obtained by subtracting the length (48 hours) of the viewing period 106 from the service last time 131, and calculates the period as the viewing expiration time for first-time viewing 116.

The terminal to reproduce the SD card 113 for the first time calculates, based on the time of the first-time viewing, a start date and an end date for which the encrypted rental content 101 can be viewed. A viewing expiration time 117 in the license information 115 is an area for writing the calculated start date and end date. When the license information conversion unit 114 creates the license information 115, only the area is defined and a specific value is not yet written in the area as shown in FIG. 2(B).

Just before the encrypted rental content 101 and the license information 115 are written out into the SD card 113, the card writing-out unit 112 doesn't write the encrypted rental content 101 and the license information 115 into the SD card 113 in case the present time exceeds the viewing expiration time for first-time viewing 116.

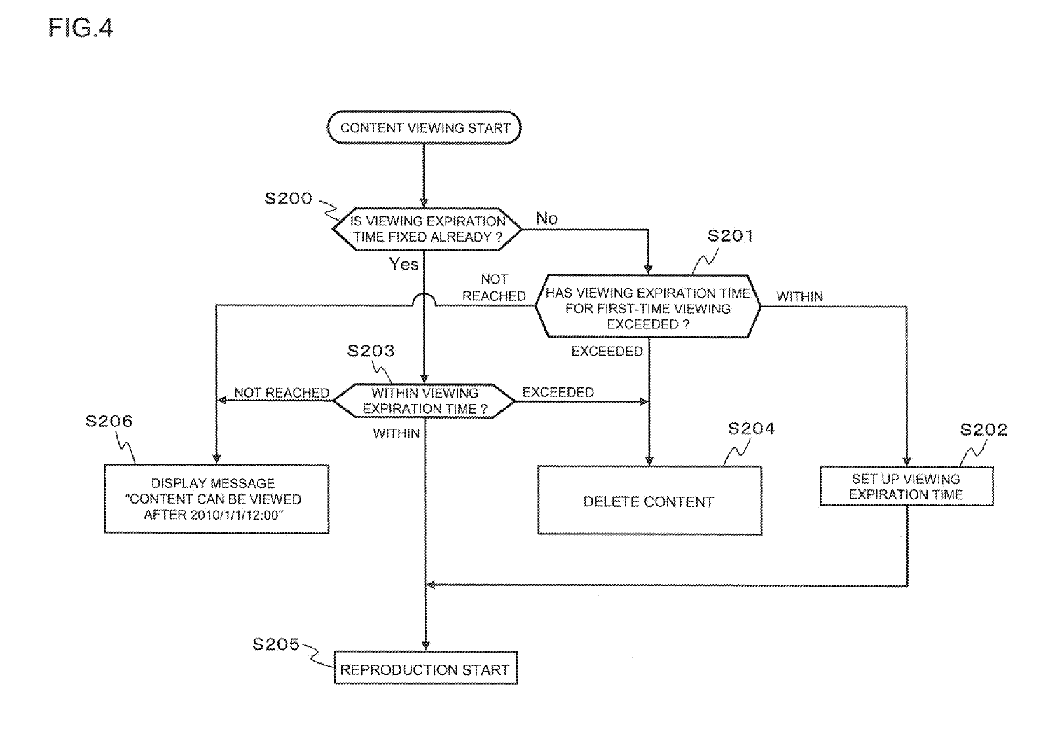

FIG. 4 is a flowchart showing the viewing expiration time decision processing by the viewing expiration time judgment unit 123 in the viewing terminal 120 for viewing the encrypted rental content 101 on the SD card 113, according to the first embodiment.

In the viewing terminal 120, the SD card reading and writing unit 121 reads out the license information 115 from the SD card 113. The viewing expiration time judgment unit 123 receives the license information 115 and checks whether the viewing expiration time 117 is already set (step S200). When the viewing expiration time 117 is not set, the viewing expiration time judgment unit 123 judges that the content has not been viewed yet, and checks whether the present time is within the period of viewing expiration time for first-time viewing (step S201) by comparing the present time with the viewing expiration time for first-time viewing 116.

When the present time has already exceeds the viewing expiration time for first-time viewing, it means that a period within which the service can be performed has already ended. Then, the encrypted rental content 101 is deleted in step S204.

When the present time has not yet reached the viewing expiration time for first-time viewing 116, the user is shown that the present time is before the time in which the content can be viewed, and reproduction of the content is not started (step S206).

When the present time is within the viewing expiration time for first-time viewing 116, the viewing expiration time judgment unit 123 calculates the viewing expiration time 117 based on the present time and the viewing period 106. The viewing expiration time judgment unit 123 further writes, as the license information 125 on the SD card 113, the viewing expiration time 117 back into the SD card 113 (step S202).

FIG. 2(C) shows an example of a configuration of the license information 125 set by the viewing expiration time judgment unit 123 by calculating the viewing expiration time 117.

When the time is a viewing start time for first-time viewing 133 (2010/5/1/18:00) as shown in FIG. 3, the viewing expiration time 117 is calculated and fixed as a period from the viewing start time for first-time viewing 133 to the time (2010/5/3/18:00), to which the 48 hours indicated by the viewing period 106 is added, as shown in FIG. 2(C). The viewing expiration time 117 is, as the license information 125, written back into the SD card 113.

When the viewing expiration time 117 is already set and fixed in step S200, the viewing expiration time judgment unit 123 compares the viewing expiration time 117 with the present time (step S203). When the present time is within the viewing expiration time 117, the viewing expiration time judgment unit 123 starts reproduction of the encrypted rental content 101 (step S205).

When the present time has already exceeded the viewing expiration time 117, the encrypted rental content 101 is deleted (step S204) because the user's viewing right has been already lost. When the present time has not yet reached the start date of the viewing expiration time 117, the user is shown that the present time is before the time in which the encrypted rental content 101 can be viewed, and reproduction of the content is not started (step S206).

Thus, even after the encrypted rental content 101 is written out to the SD card 113, the service providing period 105 intended by the content right holder and the service dealer can be complied with.

In the first embodiment, as for an operation for calculating the viewing expiration time for first-time viewing 116 from the service providing period 105, subtraction is performed on the side of the download terminal 110. However, a method of calculating the viewing expiration time for first-time viewing 116 is not limited to this. When a result of the subtraction performed on the side of the server 100 is transmitted to the download terminal 110, the same effect can be produced even if the license information conversion unit 114 doesn't perform subtraction. Furthermore, when the viewing expiration time for first-time viewing 116 showing a period within which the viewing period 106 is allowed to be changed to the viewing expiration time 117 is given from the server 100 to the download terminal 110 in advance, the same effect can be produced without performing subtraction.

In the first embodiment, the period obtained by subtracting the viewing period 106 from the service last time 131 of the service providing period 105 is assigned to the viewing expiration time for first-time viewing 116. Alternatively, calculating the length of a period obtained by adding a predetermined time (e.g., 3 hours) to the viewing period 106, a period obtained by subtracting the calculated length from the service last time 131 of the service providing period 105 can be assigned to the viewing expiration time for first-time viewing 116. In this way, the service providing period intended by the content right holder and the service dealer can be complied with more certainly.

In the first embodiment, the encrypted rental content 101 on the SD card 113 is deleted in step S204. The encrypted rental content 101 can be invalidated by disabling readout from the SD card 113 or use for the content, instead of deleting the encrypted rental content 101.

In the first embodiment, in FIG. 3, when the viewing start time for first-time viewing in the viewing terminal 120 exceeds the viewable last time for first-time viewing 132, which is the last time of the viewing expiration time for first-time viewing 116, it is judged that the present time exceeds the viewing expiration time for first-time viewing in step S201 in FIG. 4 even if the present time has not yet reached the service last time 131, which is the last time of the service providing period 105. Then, the encrypted rental content 101 is not allowed to be reproduced. This is because the viewing period 106 (48 hours in this case), which is given to the user, cannot be reserved when the first viewing in the viewing terminal 120 is started after the viewable last time for first-time viewing 132. An unreservable period of the viewing period 140 shown in FIG. 3 shows a period within the service providing period 105 for which the viewing period 106 cannot be reserved in case the first viewing is started.

It is not possible to reserve the viewing period 106 in the unreservable period of the viewing period 140. But the user can be allowed to view the content in the unreservable period of the viewing period 140 because the period is within the service providing period 105.

For example, if the present time is within the unreservable period of the viewing period 140 when the license information conversion unit 114 in the download terminal 110 creates the license information 115, the license information conversion unit 114 can (i) create license information 141 with the viewing expiration time 117 such that absolute time information is set so as to include the present time as the start time and the service last time 131 as the last time, and (ii) write the viewing expiration time 117 into the SD card 113.

The time which is set as the last time of the viewing expiration time 117 in this case corresponds to an example of an expiration time limit at which the content can be viewed according to the present invention.

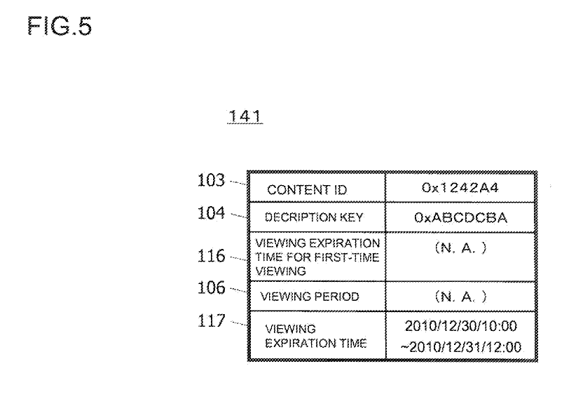

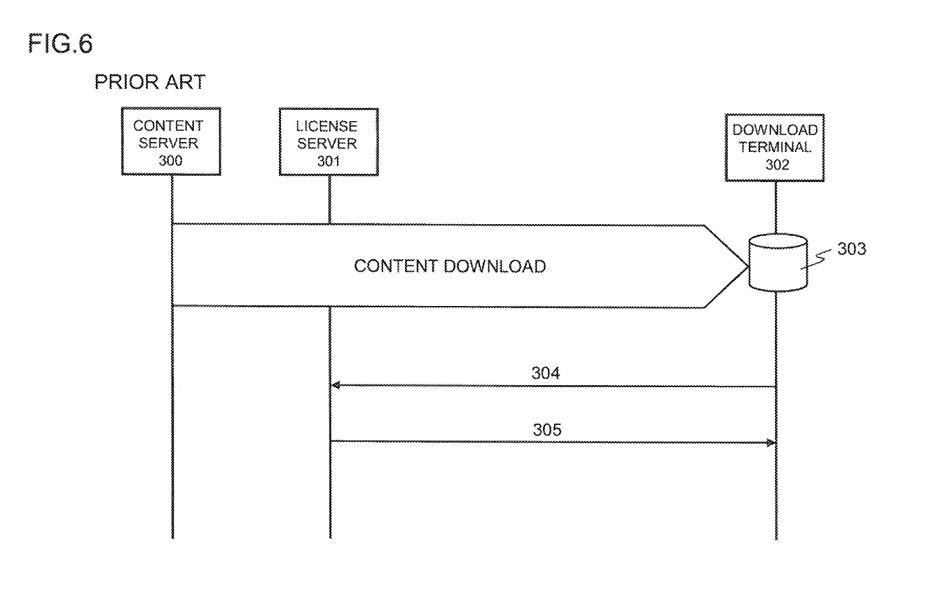

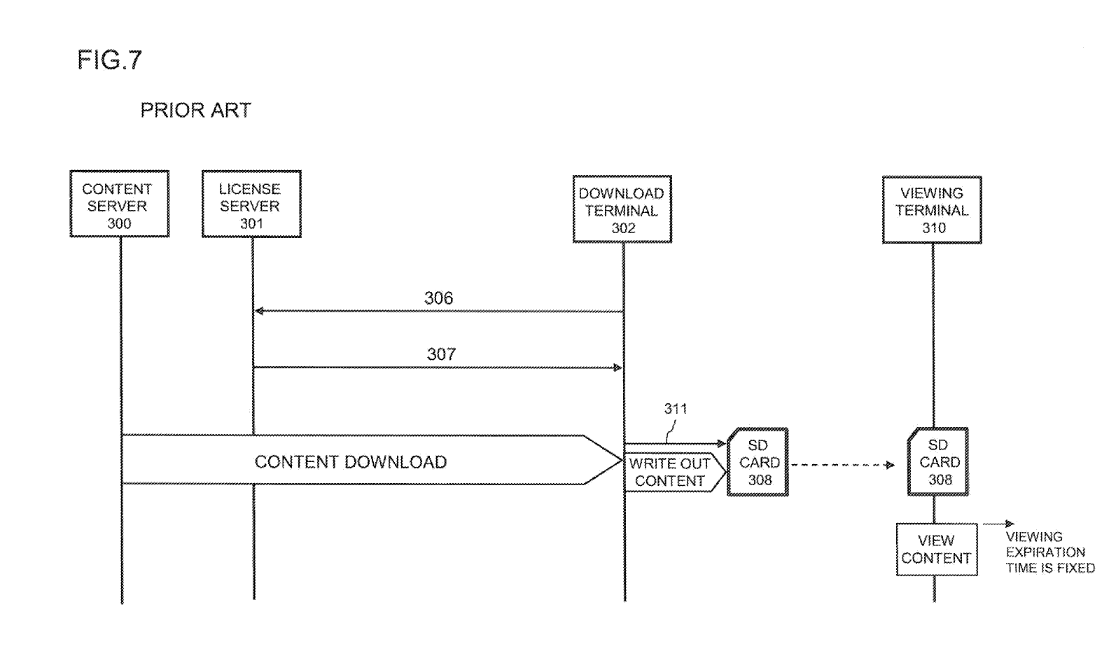

FIG. 5 shows an example of a configuration of the license information 141 written out to the SD card 113.

FIG. 5 shows a case in which the license information 141 is written out to the SD card 113 at 2010/12/30/10:00, which is a time within the unreservable period of the viewing period 140 that exceeds the viewable last time for first-time viewing 132 (2010/12/29:12:00) but doesn't exceed the service last time 131 (2010/12/31/12:00). In this case, the viewing period 106 (48 hours) cannot be reserved. However, the encrypted rental content 113 on the SD card 113 can be viewed in the viewing terminal 120 within the period indicated by the viewing expiration time in the license information 141.

In this case, since the information on the viewing expiration time for first-time viewing 116 and the viewing period 106 is unnecessary, such information is not set in the license information 141 in FIG. 5. However, the related values can be still set, so that the viewing expiration time judgment unit 123 in the viewing terminal 120 gives priority, for judgment, to a value of the viewing expiration time 117 over these values.

In step S201, when the present time exceeds the viewing expiration time for first-time viewing 116, the viewing expiration time judgment unit 123 in the viewing terminal 120 can judge whether the present time is within the viewing period 140 or not to set the viewing expiration time 117.

That is, when an instruction from the user to request the first-time viewing start is received, the present time is compared with the time obtained by adding the viewing period 106 to the viewable last time for first-time viewing 132, which is the last time of the viewing expiration time for first-time viewing 116. When the present time doesn't exceed the time obtained, it is judged that the content can be viewed, and absolute time information, which shows a period such that the start time is the present time and the last time is the time obtained by adding the viewing period 106 to the viewable last time for first-time viewing 132, is set as the viewing expiration time 117 of the license information 141. The license information 141 is then written back into the SD card 113, so that reproduction of the encrypted rental content 101 on the SD card 113 is started.

In this way, the service providing period intended by the content right holder and the service dealer can be complied with, and the user can view the encrypted rental content 101 until the service last time 131 of the service providing period 105.

When the process in which the license information conversion unit 114 in the download terminal 110 creates the license information 115 is performed by software which executes a program by using a CPU, a specification change of the composition of the license information 102, the license information 115, etc. can be supported flexibly. Similarly, when the processes concerning the viewing expiration time judgment unit 123 and the reproduction control unit 124 are performed by software, a specification change of the composition of the license information 115 or the like can be supported flexibly.

The non-transitory computer-readable medium of the present invention is a recording medium having recorded thereon a program of the above-described content reproducing method of the present invention and is a recording medium the program of which, when read, is used in cooperation with the computer.

The computer according to the present invention described above is not limited to pure hardware such as a CPU and may include firmware, an OS, and peripheral equipment.

As described above, the configuration of the present invention may be realized in terms of software or may be realized in terms of hardware.

The content receiver, the content use system, the content reproducing method and the like according to the present invention have an effect of complying with a service providing period even when a content such as a rental content the viewing expiration time of which is not fixed is written out to an exchangeable medium, and are useful as a content receiver, a content use system, a content reproducing method or the like for writing out a rental content having a limited viewing expiration time to an exchangeable medium.

What is claimed is:

1. A content receiver which receives a content that is permitted to be viewed during a permitted viewing period of a predetermined time length from a first reproduction, from a content server and writes out the content to an exchangeable medium, the content receiver comprising:
a period information receiving unit which receives, from the content server, information about the permitted viewing period and a fixed providing period, the fixed providing period being a period which is fixed by an absolute time for every content and during which a reproduction is permitted;
a reproduction startable period creation unit which acquires a reproduction startable period during which a start of the reproduction is permitted, based on the permitted viewing period and the fixed providing period; and
a writing-out unit which writes out the reproduction startable period, the permitted viewing period and the content, to the exchangeable medium.

2. The content receiver according to claim 1, wherein
the reproduction startable period creation unit assigns, as a last time of the reproduction startable period, a time which is obtained by subtracting the permitted viewing period from a last time of the fixed providing period.

3. The content receiver according to claim 1, wherein
when a timing of writing-out exceeds the reproduction startable period, the writing-out unit does not write out the content to the exchangeable medium.

4. The content receiver according to claim 1, wherein
when a timing of writing-out exceeds the reproduction startable period but does not exceed the fixed providing period, the writing-out unit writes out a last time of the fixed providing period as an expiration time limit at which the content can be viewed, to the exchangeable medium.

5. A content use system comprising: a content server which stores a content that is permitted to be viewed during a permitted viewing period of a predetermined time length from a first reproduction; a content receiver which receives the content from the content server and writes out the content to an exchangeable medium; and a content reproducer which reproduces the content recorded on the exchangeable medium, wherein
the content server includes a period information transmitting unit which transmits, to the content receiver, information about the permitted viewing period and a fixed providing period, the fixed providing period being a period which is fixed by an absolute time for every content and during which a reproduction is permitted,
the content receiver includes a period information receiving unit which receives the permitted viewing period and the fixed providing period from the content server, a reproduction startable period creation unit which acquires a reproduction startable period during which a start of the reproduction is permitted, based on the permitted viewing period and the fixed providing period, and a writing-out unit which writes out the reproduction startable period, the permitted viewing period and the content to the exchangeable medium, and
the content reproducer includes a content reproduction unit which compares a present time with the reproduction startable period at a time of starting reproduction of the content recorded on the exchangeable medium, (i) adds the permitted viewing period to the present time, sets the added time as an expiration time limit at which the content can be viewed, and reproduces the content, when the present time is within the reproduction startable period, (ii) does not reproduce the content, when the present time is before the reproduction startable period, (iii) and does not reproduce the content, when the present time is after the reproduction startable period and a predetermined condition is satisfied.

6. The content use system according to claim 5, wherein
the predetermined condition is that the present time has exceeded an added time which is obtained by adding the permitted viewing period to a last time of the reproduction startable period, and
when the present time is after the reproduction startable period and does not exceed the added time, the content reproduction unit sets the added time as the expiration time limit and reproduces the content.

7. The content use system according to claim 5, wherein
when the present time has exceeded the reproduction startable period, the content reproduction unit deletes or invalidates the content irrespective of whether the predetermined condition is satisfied.

8. A content reproducing method for a content use system including a content server which stores a content that is permitted to be viewed during a permitted viewing period of a predetermined time length from a first reproduction, a content receiver which receives the content from the content server and writes out the content to an exchangeable medium, and a content reproducer which reproduces the content recorded on the exchangeable medium, the content reproducing method comprising:
a period information transmitting step of transmitting, from the content server to the content receiver, information about the permitted viewing period and a fixed providing period, the fixed providing period being a period which is fixed by an absolute time for every content and during which a reproduction is permitted;
a reproduction startable period creation step of, by the content receiver, acquiring a reproduction startable period during which a start of the reproduction is permitted, based on the permitted viewing period and the fixed providing period;
a writing-out step of, by the content receiver, writing out the reproduction startable period, the permitted viewing period and the content to the exchangeable medium; and
a content reproduction step of, by the content reproducer, comparing a present time with the reproduction startable period at a time of starting reproduction of the content recorded on the exchangeable medium, (i) adding the permitted viewing period to the present time, setting the added time as an expiration time limit at which the content can be viewed, and reproducing the content, when the present time is within the reproduction startable period, (ii) not reproducing the content, when the present time is before the reproduction startable period, (iii) and not reproducing the content, when the present time is after the reproduction startable period and a predetermined condition is satisfied.

9. A non-transitory computer-readable medium having a program stored thereon, wherein the program causes a computer to execute the content reproducing method according to claim 8.
